(19) United States
(12) Patent Application Publication
(10) Pub. No.: US 2024/0397120 A1
(43) Pub. Date: Nov. 28, 2024

(54) METHOD AND APPARATUS FOR PRESENTING LIVE-STREAMING INFORMATION, ELECTRONIC DEVICE AND STORAGE MEDIUM

(71) Applicant: BEIJING YOUZHUJU NETWORK TECHNOLOGY CO. LTD., Beijing (CN)

(72) Inventors: Xue Zhou, Beijing (CN); Yanhao Li, Beijing (CN); Ziyun Wei, Beijing (CN)

(21) Appl. No.: 18/696,269

(22) PCT Filed: Sep. 27, 2022
(86) PCT No.: PCT/CN2022/121734

§ 371 Date: Mar. 27, 2024

(30) Foreign Application Priority Data
Sep. 27, 2021 (CN) 202111138812.9

(51) Int. Cl. H04N 21/2187

(52) U.S. Cl. CPC H04N 21/2187

(57) ABSTRACT

Embodiments of the disclosure disclose a method and apparatus for presenting live-streaming information, an electronic device and a storage medium. The method includes: receiving a live-streaming information recording request from an object provider, and presenting a live-streaming information recording interface, wherein the live-streaming information recording interface presents at least one live-streaming room identifier corresponding to the object provider; receiving a live-streaming room identifier selection operation inputted for the at least one live-streaming room identifier, taking a live-streaming room corresponding to the selected live-streaming room identifier as a target live-streaming room, and presenting a completed live-streaming time period corresponding to the target live-streaming room; and receiving an information input operation for the completed live-streaming time period, and presenting live-streaming information corresponding to the information input operation.

### CROSS-REFERENCE

This application is based on and claims priority of the Chinese Patent Application No. 202111138812.9, filed on Sep. 27, 2021, which is incorporated herein by reference in its entirety.

### FIELD

Embodiments of the present disclosure relate to the field of information interaction technologies, and for example, relate to a method and apparatus for presenting live-streaming information, an electronic device and a storage medium.

### BACKGROUND

As Internet technologies and the e-commerce industry develop, e-commerce live-streaming has been favored by the majority of users due to its real-time nature, interactivity, intuitive visual impact and the like. Live-streaming data is particularly important as one of the indicators to measure the live-streaming quality. With respect to the statistics of the live-streaming information in the related art, only the check of statistical data is available, without providing the function of interacting with the users.

### SUMMARY

Embodiments of the present disclosure provide a method and apparatus for presenting live-streaming information, an electronic device and a storage medium, in order to achieve systematic and elaborate recording of live-streaming information.

In a first aspect, a method for presenting live-streaming information is provided according to the embodiments of the present disclosure. The method includes:
receiving a live-streaming information recording request for an object provider, and presenting a live-streaming information recording interface, wherein the live-streaming information recording interface presents at least one live-streaming room identifier corresponding to the object provider;
receiving a live-streaming room identifier selection operation for the at least one live-streaming room identifier, taking a live-streaming room corresponding to the selected live-streaming room identifier as a target live-streaming room, and presenting a completed live-streaming time period corresponding to the target live-streaming room; and
receiving an information input operation for the completed live-streaming time period, and presenting live-streaming information corresponding to the information input operation.

In a second aspect, an apparatus for presenting live-streaming information is further provided according to the embodiments of the present disclosure. The apparatus includes:
an interface presenting module configured to receive a live-streaming information recording request for an object provider, and present a live-streaming information recording interface, wherein the live-streaming information recording interface presents at least one live-streaming room identifier corresponding to the object provider;
an account selecting module configured to receive a live-streaming room identifier selection operation for the at least one live-streaming room identifier, take a live-streaming room corresponding to the selected live-streaming room identifier as a target live-streaming room, and present a completed live-streaming time period corresponding to the target live-streaming room; and
a live-streaming information presenting module configured to receive an information input operation for the completed live-streaming time period, and present live-streaming information corresponding to the information input operation.

In a third aspect, an electronic device is further provided according to the embodiments of the present disclosure. The electronic device includes:
at least one processor; and
a storage apparatus configured to store at least one program, wherein
the at least one program, when executed by the at least one processor, enables the at least one processor to implement the method for presenting the live-streaming information provided by any embodiment of the present disclosure.

In a fourth aspect, a computer-readable storage medium is further provided according to the embodiments of the present disclosure. The computer-readable storage medium stores a computer program therein, wherein the computer program, when executed by a processor, implements the method for presenting the live-streaming information provided by any embodiment of the present disclosure.

### BRIEF DESCRIPTION OF THE DRAWINGS

FIG. 1A is a schematic flowchart of a method for presenting live-streaming information provided by Embodiment 1 of the present disclosure;

FIG. 1B is a schematic diagram of a live-streaming information presenting interface provided by Embodiment 1 of the present disclosure;

FIG. 1C is a schematic diagram of another live-streaming information presenting interface provided by Embodiment 1 of the present disclosure;

FIG. 1D is a schematic diagram of yet another live-streaming information presenting interface provided by Embodiment 1 of the present disclosure;

FIG. 2A is a schematic flowchart of a method for presenting live-streaming information provided by Embodiment 2 of the present disclosure;

FIG. 2B is a schematic diagram of an online live-streaming recording float layer provided by Embodiment 2 of the present disclosure;

FIG. 2C is a schematic diagram of another online live-streaming recording float layer provided by Embodiment 2 of the present disclosure;

FIG. 2D is a schematic diagram of another live streamer information entry interface provided by Embodiment 2 of the present disclosure;

FIG. 2E is a schematic diagram of another live streamer information entry interface provided by Embodiment 2 of the present disclosure;

FIG. 3 is a schematic structural diagram of an apparatus for presenting live-streaming information provided by Embodiment 3 of the present disclosure; and

FIG. 4 is a schematic structural diagram of an electronic device provided by Embodiment 4 of the present disclosure.

### DETAILED DESCRIPTION

The present disclosure will be further described below in conjunction with the accompanying drawings and embodiments.

In addition, it should be noted that, for ease of description, only the parts related to the present disclosure, not all content, are shown in the accompanying drawings. Prior to discussing the exemplary embodiments in more detail, it should be mentioned that some of the exemplary embodiments are described as processing or methods depicted as flowcharts. Although a flowchart describes operations (or steps) as sequential processing, many of these operations may be performed in parallel, concurrently, or simultaneously. In addition, the order of the operations may be rearranged. The processing may be terminated when its operations are completed, but may also include additional steps not included in the accompanying drawings. The processing may correspond to methods, functions, procedures, subroutines, subprograms, and the like.

### Embodiment 1

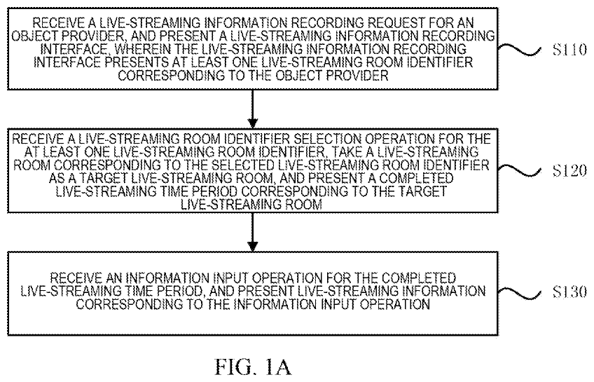

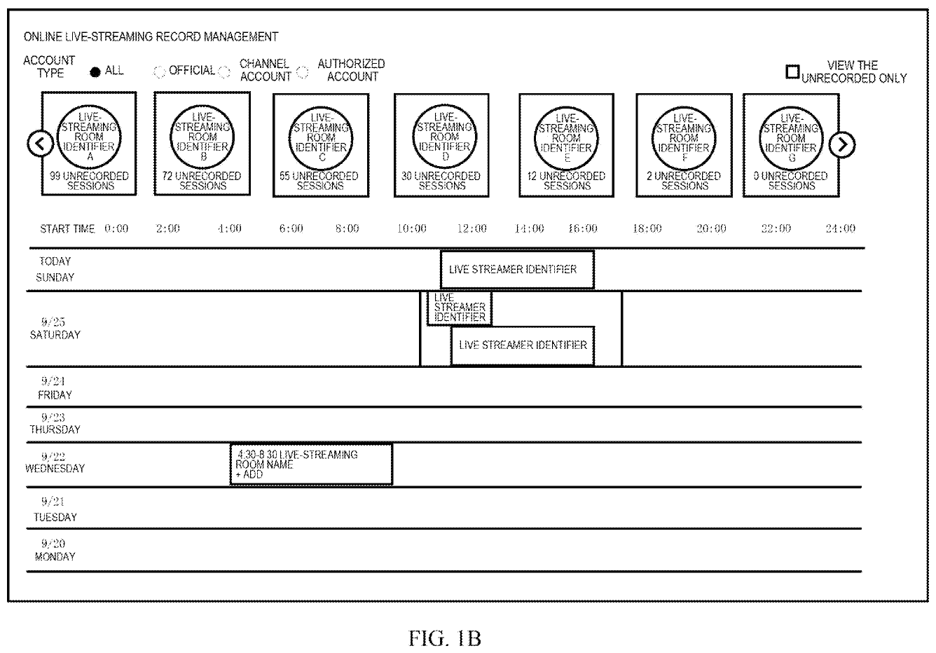

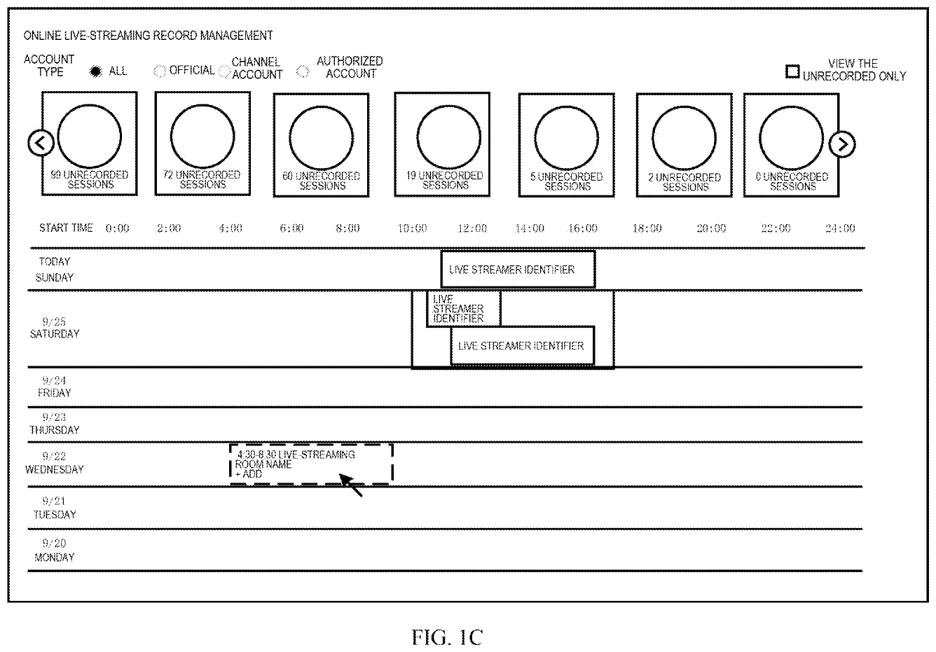

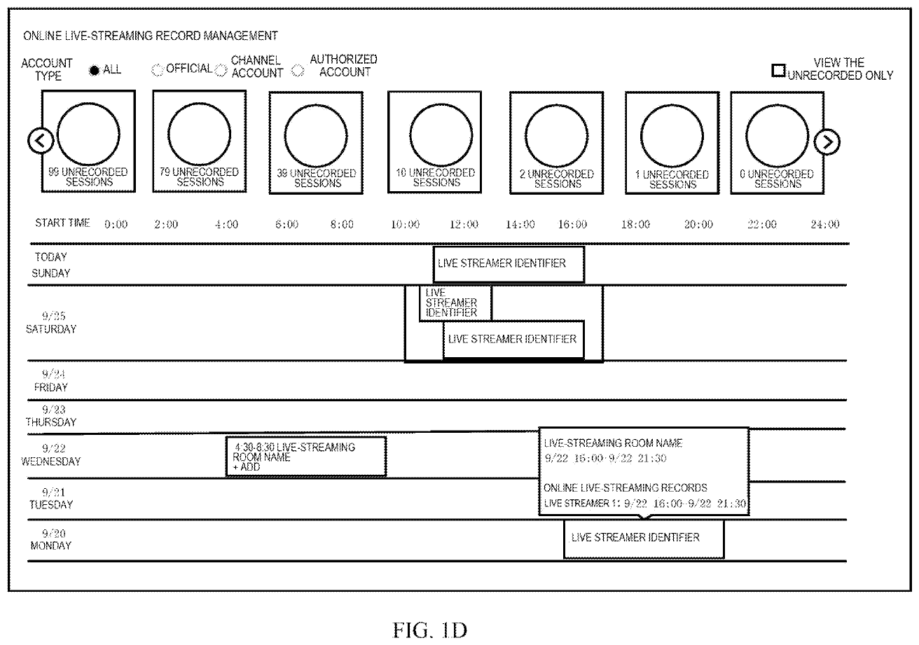

FIG. 1A is a schematic flowchart of a method for presenting live-streaming information provided by Embodiment 1 of the present disclosure. This embodiment may be applied to a case of fine-grained recording for live-streaming information. This method may be performed by an apparatus for presenting live-streaming information. This apparatus may be implemented through software and/or hardware, and may be disposed in a terminal and/or server to implement the method for presenting the live-streaming information in this embodiment of the present disclosure.

As shown in FIG. 1A, the method according to this embodiment includes the following steps.

In S110, a live-streaming information recording request for an object provider is received, and a live-streaming information recording interface is presented, wherein the live-streaming information recording interface presents at least one live-streaming room identifier corresponding to the object provider.

An object may be either a physical object or a virtual object. Exemplarily, an object in a trading scenario may be a virtual item or a physical item used for trading. The object provider may be interpreted as a party that provides the object. The object provider may be a user account with at least one live-streaming room identifier that supports a live-streaming function. The live-streaming information recording request may be interpreted as a request for recording live-streaming information initiated by the object provider. The live-streaming information recording interface may be interpreted as an interactive interface for users to view or record the live-streaming information of the live-streaming room identifier corresponding to the object provider. The live-streaming information recording interface may, but is not limited to, present at least one of at least one live-streaming room identifier corresponding to the object provider, a live-streaming information recording state corresponding to each live-streaming room identifier, a live-streaming room identifier selection control, a live-streaming room identifier switching control, calendar information, recorded live-streaming information, and the like.

Optionally, the live-streaming room identifier may be presented in a form of presenting a live-streaming room avatar and a live-streaming room name. The live-streaming information recording state corresponding to each live-streaming room identifier may be recorded in a form of marking an unrecorded session in the live-streaming information, in which no completed session is recorded, corresponding to this live-streaming room identifier in a live-streaming room identifier presenting area. Exemplarily, the number of unrecorded sessions may be used to determine the live-streaming information recording state corresponding to each live-streaming room identifier. For example, the number of unrecorded session being 0 indicates that it is unnecessary for this live-streaming room identifier to record the live-streaming information, or all live-streaming information of the live-streaming sessions that have been carried out in this live-streaming room identifier has been recorded. The number of unrecorded sessions corresponding to the live-streaming room identifier being greater than or equal to 1 indicates that a live-streaming session/sessions, in which live-streaming information has not been recorded, exists/exist in this live-streaming room identifier.

Exemplarily, the live-streaming room identifier selection control may include an account type selection control, for example, may be at least one of controls, such as all selection controls, official account selection controls, channel account selection controls, and authorized account selection controls. The live-streaming room identifier switching control may be interpreted as a control set in the live-streaming room identifier displaying area and used to switch a currently presented live-streaming room identifier, such as a page-turning button and/or a shift button. In order to allow users to understand a presenting condition of the live-streaming room identifier conveniently, a presenting state (e.g., a button color) of the live-streaming room identifier switching control may be adjusted according to the presenting condition of the live-streaming room identifier. For example, taking the live-streaming room identifier switching control being the page-turning button and the page-turning button including a left page-turning button and a right page-turning button as an example, the left page-turning button may be grayed when a first page of a live-streaming room identifier is presented, and right page-turning button may be grayed when a last page of the live-streaming room identifier is presented.

The calendar information may include both a vertical time axis and a horizontal time axis. Considering that most live-streaming records are used in a landscape mode, the vertical time axis may be set to a date time axis, and the horizontal time axis may be set to an hour time axis. It should be noted that a minimum time unit of the date time axis and the hour time axis may be set according to actual needs, and is not limited herein. For example, the date time axis is accurate to month and day, and the hour time axis is accurate to minute, second, etc.

Exemplarily, the live-streaming information recording interface may present live-streaming room identifiers with live-streaming records within a time range selected based on the calendar information. The live-streaming identifier may be marked with the number of unrecorded sessions (e.g., 23 unrecorded sessions) in live-streaming information in which no completed live-streaming session is recorded, to show how many live-streaming sessions do not have recorded live-streaming information. The presenting of the live-streaming room identifiers is ranked based on a principle that the live-streaming room identifiers with unrecorded sessions are ranked first.

In this embodiment of the present disclosure, there may be a variety of ways to receive a live-streaming information recording request from an object provider, which is not limited herein. For example, an operation that is acted on a preset request control for initiating a live-streaming information recording request from the object provider is received, or a target triggering operation for a user-initiated live-streaming information recording request from the object provider inputted in a preset detection area is detected, etc.

Optionally, the live-streaming information recording interface may be presented by switching a current display interface to a live-streaming information recording interface, or by presenting the live-streaming information recording interface in a preset live-streaming information displaying area of the current display interface.

It should be noted that one object provider may be provided with one, two, or more live-streaming rooms. Therefore, the live-streaming information recording interface may present at least one live-streaming room identifier corresponding to the object provider. In other words, the live-streaming information recording interface may present all or part of live-streaming room identifiers corresponding to the object provider.

When the live-streaming information recording interface presents a plurality of live-streaming room identifiers corresponding to the object provider, the plurality of live-streaming room identifiers corresponding to the object provider may be presented in accordance with a preset account arrangement rule. The account arrangement rule may determine the ranking of the live-streaming room identifiers according to at least one of the number of fans corresponding to the live-streaming room identifier, the live-streaming frequency, the number of live-streaming sessions, the account opening time, the live-streaming debut time and other information. Of course, the account arrangement rule may also determine the ranking according to names of the live-streaming room identifiers, according to user operation data, or randomly.

When the live-streaming information recording interface cannot present all the live-streaming room identifiers corresponding to the object provider, the live-streaming room identifiers may be presented in batches or pages. Optionally, the method for presenting the live-streaming information in this embodiment of the present disclosure further include: receiving a live-streaming room identifier switching operation inputted based on the live-streaming information recording interface, and switching at least one live-streaming room identifier currently presented in the live-streaming information recording interface. Such setting can support the user to view all the live-streaming room identifiers corresponding to the object provider.

Exemplarily, receiving the live-streaming room identifier switching operation inputted based on the live-streaming information recording interface may refer to receiving a triggering operation which is acted on the live-streaming room identifier switching control for switching the live-streaming room identifier set on the live-streaming information recording interface. The live-streaming room identifier switching control may be set in the live-streaming room identifier presenting area. In this embodiment of the present disclosure, the live-streaming room identifier switching control may be presented in the form of a preset character and/or pattern, etc. The presenting form of the live-streaming room identifier switching control is not limited herein.

Optionally, switching the at least one live-streaming room identifier currently presented in the live-streaming information recording interface includes: switching all or part of the live-streaming room identifiers currently presented in the live-streaming information recording interface. For example, when the live-streaming room identifier switching operation inputted based on the live-streaming information recording interface is received, the live-streaming room identifier presenting area is controlled to perform a page-turning operation to switch all the live-streaming room identifiers currently presented in the live-streaming information recording interface. Alternatively, when the live-streaming room identifier switching operation inputted based on the live-streaming information recording interface is received, a preset number of live-streaming room identifiers which are ranked first and currently presented in the live-streaming information recording interface are removed, and live-streaming room identifiers to be presented corresponding to the object provider, the number of which is less than or equal to the preset number, are added for displaying. The preset number may be set according to actual needs, for example, may be 1, 2, 3, 5, etc., which is not limited herein.

Exemplarily, adding the live-streaming room identifiers to be presented corresponding to the object provider, the number of which is less than or equal to the preset number, for displaying includes: determining the number to be presented of live-streaming room identifiers to be presented corresponding to the object provider; if the number to be presented is greater than or equal to the preset number, adding the preset number of live-streaming room identifiers to be presented corresponding to the object provider for displaying, and if the number to be presented is less than the preset number, adding all live-streaming room identifiers to be presented for displaying.

In S120, a live-streaming room identifier selection operation based on the at least one live-streaming room identifier is received, a live-streaming room corresponding to the selected live-streaming room identifier is taken as a target live-streaming room, and a completed live-streaming time period corresponding to the target live-streaming room is presented.

As described above, the live-streaming information recording interface may present at least one live-streaming room identifier corresponding to the object provider, wherein the live-streaming room identifier selection operation may be based on an operation for selecting a live-streaming room in the at least one live-streaming room identifier inputted based on an input device. Exemplarily, receiving the live-streaming room identifier selection operation inputted based on the at least one live-streaming room identifier, may refer to, when an inputted clicking operation for the presented live-streaming room identifier is received, determining that the live-streaming room identifier selection operation inputted based on the at least one live-streaming room identifier is received.

In order to allow the user to conveniently understand whether the operation is successful in a timely manner and to intuitively understand the currently selected live-streaming room identifier, the live-streaming room identifier on which the live-streaming room identifier selection operation is acted may be marked when the live-streaming room identifier selection operation inputted based on the at least one live-streaming room identifier is received. Exemplarily, a checkmark, circle or other selected identifier may be added to the lower right corner of this live-streaming room identifier, or a presenting state of this live-streaming room identifier may be adjusted. The presenting state of this live-streaming room identifier may be adjusted in such a way that a presenting area of this live-streaming room identifier is amplified for displaying, or a border color of the presenting area of this live-streaming room identifier is changed, and so on.

The target live-streaming room may be interpreted as a currently selected live-streaming room of which live-streaming information may be required to be recorded, and the target live-streaming room may be determined by means of the live-streaming room identifier selection operation inputted based on the at least one live-streaming room identifier.

The completed live-streaming time period may be interpreted as a time period corresponding to at least one live-streaming session in the target live-streaming room where live-steaming has been performed, or may also include a completed live-streaming duration and/or live-streaming name corresponding to a live-streaming session in live-streaming. It should be noted that when the completed live-streaming time period is the completed live-streaming duration corresponding to the live-streaming session in live-streaming, the completed live-streaming time period may change regularly or in real time with the change in the live-streaming time of the target live-streaming room.

Exemplarily, the completed live-streaming time period is used to record at least one of time information, such as a live-streaming start time, a live-streaming end time and a live-streaming duration of each live-streaming session in the target live-streaming room.

It may be understood that there may be a variety of ways to present the completed live-streaming time period corresponding to the target live-streaming room. For example, the completed live-streaming time period corresponding to the target live-streaming room may be presented in the form of a Gantt chart. The length of the Gantt chart may represent the length of the completed live-streaming time period, a start position of the Gantt chart indicates a start time of this live-streaming session, and an end position of the Gantt chart indicates an end time of this live-streaming session.

Exemplarily, the completed live-streaming time period with no live-streaming information added may be grayed, and a start time, an end time and a live-streaming name of this live-streaming session may be presented at the same time; and the start and end positions over the length of the completed live-streaming time period in a horizontal axis direction correspond to the start time and the end time of this live-streaming session, respectively.

With the above technical solution, the start time and the end time of the live-streaming that has been carried out in the live-streaming room are marked through the Gantt chart, which can reduce the user's memory burden. In addition, the user can automatically and accurately fill in the completed live-streaming time period corresponding to the target live-streaming room, without manually recording and finding completed live-streaming time information of the live-streaming room.

In addition, presenting the completed live-streaming time period corresponding to the target live-streaming room may also be presenting the completed live-streaming time period corresponding to the target live-streaming room in the form of a text record, calendar annotation, or the like, or presenting the completed live-streaming time period corresponding to the target live-streaming room in a combination of at least two forms.

In order to facilitate viewing, the completed live-streaming time period corresponding to the target live-streaming room may be presented on the live-streaming information recording interface. A presenting area of the completed live-streaming time period and a presenting area of the live-streaming room identifier may be arranged transversely or vertically. Of course, the arrangement mode may also be customized by the user. The arrangement mode of the presenting area of the completed live-streaming time period and the presenting area of the live-streaming room identifier is not limited.

In this embodiment of the present disclosure, the completed live-streaming time period corresponding to the target live-streaming room can be presented in response to the live-streaming room identifier selection operation for the live-streaming room identifier. In order to achieve more fine-grained recording of the live-streaming information, the presenting state of the completed live-streaming time period may also be determined based on whether the live-streaming information has already been recorded within the completed live-streaming time period corresponding to the target live-streaming room. Optionally, presenting the completed live-streaming time period corresponding to the target live-streaming room includes: presenting the completed live-streaming time period in a first presenting state if no live-streaming information is recorded within the completed live-streaming time period corresponding to the target live-streaming room; and presenting the completed live-streaming time period and recorded live-streaming information in a second presenting state if the live-streaming information has been recorded within the completed live-streaming time period corresponding to the target live-streaming room.

Presenting the completed live-streaming time period and the live-streaming information in the second presenting state includes: presenting the recorded live-streaming information in the completed live-streaming time period. Exemplarily, as shown in FIG. 1B, the presenting area of the recorded live-streaming information may be presented in or cover an upper area of the presenting area of the completed live-streaming time period.

The first presenting state may be different from the second presenting state. Exemplarily, the first presenting state may be different from the second presenting state in terms of display color or display morphology. For example, the displaying area of the completed live-streaming time period in the first presenting state may be displayed as a first color, such as gray, the displaying area of the completed live-streaming time period in the second presenting state may be displayed as a second color, and the recorded live-streaming information may be displayed in the displaying area of the completed live-streaming time period in a third color; and/or, the displaying area of the completed live-streaming time period in the first presenting state may be a first strip area, and the displaying area of the completed live-streaming time period in the second presenting state may be displayed as a second strip area, wherein the width of the first strip area is greater than that of the second strip area.

Every two of the first, second, and third colors may be the same or different from each other. Exemplarily, the first color is the same as the second color, and the second color is different from the third color. For example, the first and second colors are gray, the third color is blue, etc.

Taking the recorded live-streaming information being an online live-streaming time period corresponding to each live streamer within the completed live-streaming time period as an example, continuing to FIG. 1B, if the earliest live-streaming start time among the online live-streaming time periods of all live streamers in all recorded live-streaming information corresponding to the completed live-streaming time period is later than the start time of the completed live-streaming time period, or if the latest live-streaming end time among the online live-streaming time periods of all live streamers in all recorded live-streaming information corresponding to the completed live-streaming time period is earlier than the end time of the completed live-streaming time period, that is, the online live-streaming time periods of the live streamers in all recorded live-streaming information corresponding to the completed live-streaming time period do not fill up this completed live-streaming time period, an unfilled area of the completed live-streaming time period is still displayed in the second color to prompt that the live-streaming time within the completed live-streaming time period has not been completely occupied.

Such setting can intuitively distinguish whether the live-streaming information has been recorded within the completed live-streaming time period, which is conducive to viewing the recorded live-streaming information.

In this embodiment of the present disclosure, the method for presenting the live-streaming information further includes: receiving a time selection operation inputted based on the live-streaming information recording interface, and presenting a completed live-streaming time period which corresponds to the target live-streaming room and is within the target time period corresponding to the time selection operation.

The time selection operation may be an operation that selects a target time period required to be presented. Exemplarily, a preset time period that is closest to the current moment, such as the last 7 days, the last 15 days, or the last 30 days, or a specific time period, such as a specific day of a specific month of a specific year to a specific day of a specific month of a specific year may be selected. The time selection operation may be a time entry operation, a time axis scrolling operation, or the like.

Exemplarily, receiving the time selection operation inputted based on the live-streaming information recording interface may refer to receiving a time selection operation acted on the calendar information presented on the live-streaming information recording interface. For example, it may refer to receiving a scrolling, dragging or sliding operation or other operation in a vertical time axis and/or horizontal time axis acted on the calendar information presented on the live-streaming information recording interface.

In S130, an information input operation for the completed live-streaming time period is received, and live-streaming information corresponding to the information input operation is presented.

The information input operation may be interpreted as an inputted operation for recording the live-streaming information corresponding to the target live-streaming room within the completed live-streaming time period. The live-streaming information may include live streamer information and/or online live-streaming time information corresponding to a live streamer, and the like.

Optionally, receiving the information input operation inputted based on the completed live-streaming time period includes: receiving an information input triggering operation acted on an information input triggering area corresponding to the completed live-streaming time period; or receiving a time period selection operation for the completed live-streaming time period and receiving a recording triggering operation acted on a preset recording triggering control, wherein the time period selection operation and the recording triggering operation are completed sequentially by a trigger object.

The recording triggering area may be a displaying area of the completed live-streaming time period, or may be a preset triggering area independent of the displaying area of the completed live-streaming time period. The recording triggering operation may be an operation for triggering the start of a live-streaming information recording function. The recording triggering operation may be generated in various ways, such as, a click operation, a press operation, a slide operation, a drag operation, a hover operation or the like. The generation modes may be determined according to actual demands, and are not limited herein.

In order to facilitate the user's perception of an interactive situation, optionally, prior to receiving the information input operation inputted based on the completed live-streaming time period, the method further includes: waking up a recording state of the completed live-streaming time period. For example, a recording activation operation acted on the completed live-streaming time period is received, and the completed live-streaming time period is switched to an activated state.

Exemplarily, receiving the recording activation operation acted on the completed live-streaming time period may refer to receiving an operation of hovering a mouse over the displaying area of the completed live-streaming time period, or receiving an operation of long-pressing a touch object or double-clicking the displaying area of the completed live-streaming time period.

Exemplarily, switching the completed live-streaming time period to the activated state may be manifested to switch the displaying area of the completed live-streaming time period from a first display color to a second display color; or switch the displaying area of the completed live-streaming time period from static displaying to dynamic displaying, etc.

As shown in FIG. 1C, when the completed live-streaming time period is switched to the activated state, a live-streaming start time and a live-streaming end time (e.g., 14:00-18:00) corresponding to the completed live-streaming time period may be displayed. Prompt information indicating that live-streaming information can be added may also be presented in the presenting area of the completed live-streaming time period. For example, a live-streaming information addition triggering control for the addition of the live-streaming information may be presented, and expressed as “+add” and “live-streaming room name”, etc.

After the live-streaming information is added, a live-streaming information viewing operation for the completed live-streaming time period may be received, and the recorded live-streaming information is presented in the form of a floating window. The live-streaming information viewing operation may be triggered by hovering over the presenting area of the completed live-streaming time period. As shown in FIG. 1D, live-streaming room name information and live streamer's online live-streaming information may be presented. Exemplarily, by triggering the recorded information or information to be recorded presented in the floating window, the online live-streaming information on the live-streaming room may be edited. The editing may be addition, deletion, modification or the like.

In related technical solutions, the user needs to manually make statistics on other live-streaming data, which occupies the user's time very much, and is not convenient for saving and viewing the data. In particular, when the same user has a plurality of live-streaming accounts and live-streaming room identifiers, the workload of data statistics will be increased, which is prone to errors, resulting in poor user experience. Moreover, different users have different data statistics methods, which is not conducive to the formation of systematic data statistics, adversely affects the comprehensive use of data, and causes waste of data resources.

In the technical solutions of this embodiment of the present disclosure, by receiving the live-streaming information recording request for the object provider, the live-streaming information recording interface is presented. In this way, in respond to the live-streaming information recording request, the live-streaming information recording interface can be presented, which provides a way to interact with users. Then, the live-streaming room identifier selection operation inputted based on the at least one live-streaming room identifier is received to accurately capture a user's viewing intent for the live-streaming room. Further, the completed live-streaming time period corresponding to the selected live-streaming room is presented, which can automatically record and present live-streaming time periods of respective live-streaming sessions that have been carried out in the target live-streaming room for users to view, thereby saving time resources and human resources for recording by users themselves. In addition, the information input operation inputted based on the completed live-streaming time period can also be received, the live-streaming information corresponding to the information input operation is presented, the user's personalized recording needs are supported on the basis of the automatic recording of the completed live-streaming time period, and the user is supported to record the live-streaming information independently. The above-mentioned technical solution solves the problems of imperfect system interactivity, insufficient systematization, large time consumption, error proneness and high possibility of data resource waste caused by manual recording of the live-streaming data, and can realize the systematic recording of the live-streaming information, which is convenient for the subsequent management, viewing and application of the live-streaming formation, thereby improving the user experience.

### Embodiment 2

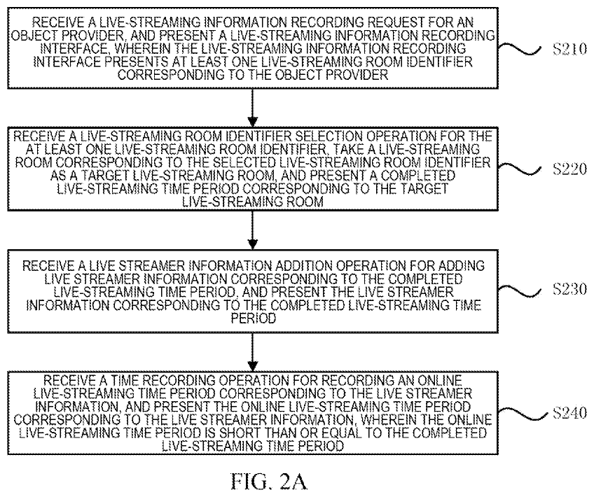

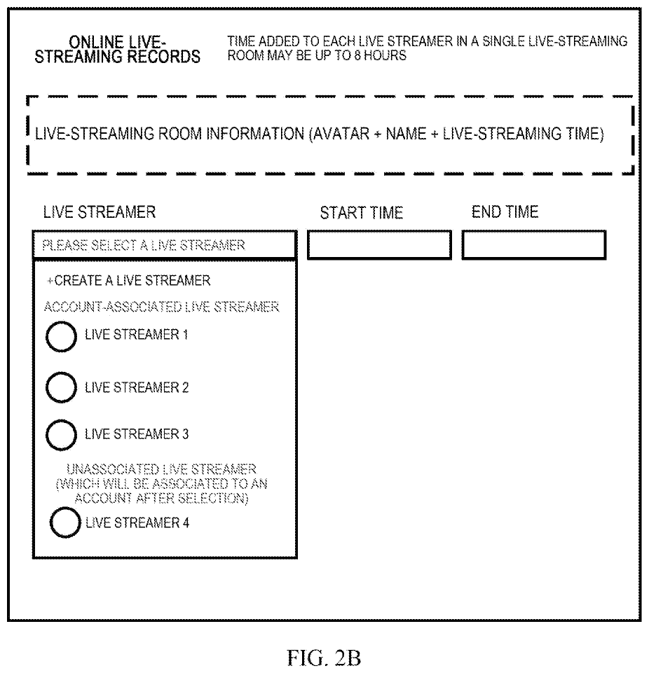

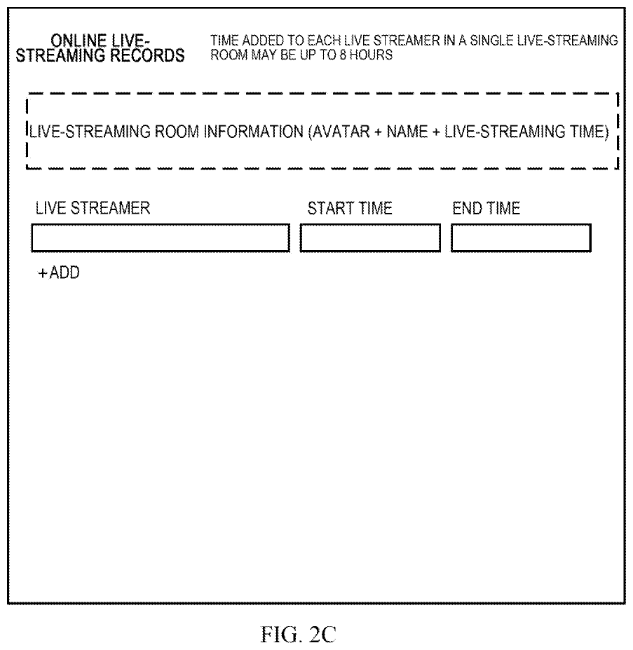

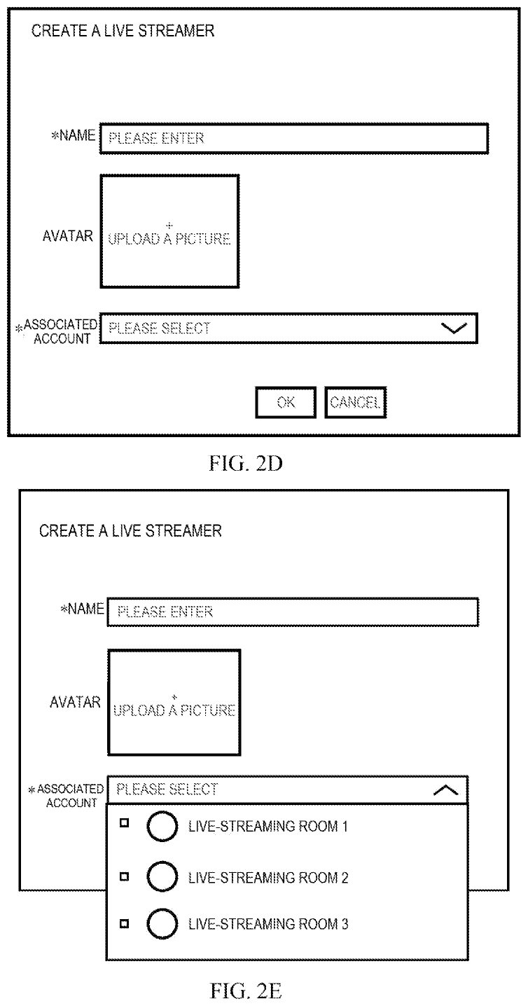

FIG. 2A is a schematic flowchart of a method for presenting live-streaming information as provided by Embodiment 2 of the present disclosure. Based on any optional technical solution in this embodiment of the present disclosure, optionally, receiving the information input operation inputted based on the completed live-streaming time period and presenting the live-streaming information corresponding to the information input operation include: receiving an live streamer information addition operation for adding live streamer information corresponding to the completed live-streaming time period, and presenting the live streamer information corresponding to the completed live-streaming time period.

Optionally, the method for presenting the live-streaming information in this embodiment of the present disclosure may further include: receiving a time recording operation for recording an online live-streaming time period corresponding to the live streamer information, and presenting the online live-streaming time period corresponding to the live streamer information, wherein a duration of the online live-streaming time period is less than or equal to the completed live-streaming time period.

The interpretation of terms identical or corresponding to each above embodiment shall not be repeated herein.

As shown in FIG. 2A, the method in this embodiment includes the following steps.

In S210, a live-streaming information recording request for an object provider is received, and a live-streaming information recording interface is presented, wherein the live-streaming information recording interface presents at least one live-streaming room identifier corresponding to the object provider.

In S220, a live-streaming room identifier selection operation for the at least one live-streaming room identifier is received, a live-streaming room corresponding to the selected live-streaming room identifier is taken as a target live-streaming room, and a completed live-streaming time period corresponding to the target live-streaming room is presented.

In S230, a live streamer information addition operation for adding live streamer information corresponding to the completed live-streaming time period is received, and the live streamer information corresponding to the completed live-streaming time period is presented.

Optionally, receiving the live streamer information addition operation for adding the live streamer information corresponding to the completed live-streaming time period and presenting the live streamer information corresponding to the completed live-streaming time period include: receiving a live streamer information addition request acted on the completed live-streaming time period, presenting an online live-streaming recording float layer corresponding to the live streamer information addition request, receiving an information addition operation for adding the live streamer information corresponding to the completed live-streaming time period in the online live-streaming recording float layer, and presenting the added live streamer information. Receiving the live streamer information addition request acted on the completed live-streaming time period may refer to receiving an area clicking operation for a displaying area of the completed live-streaming time period, and generating the live streamer information addition request based on the area clicking operation.

Exemplarily, the online live-streaming recording float layer may be presented in the form of a window containing at least one input box that may be used for input of the live streamer information.

Optionally, receiving the live streamer information addition operation for adding the live streamer information corresponding to the completed live-streaming time period and presenting the live streamer information corresponding to the completed live-streaming time period include: receiving a live streamer recording operation for recording the live streamer information corresponding to the completed live-streaming time period, and presenting at least one live streamer identifier associated with the target live-streaming room; and receiving a live streamer identifier selection operation inputted for at least one live streamer identifier associated with the target live-streaming room, and presenting the live streamer information corresponding to the completed live-streaming time period.

The at least one live streamer information associated with the target live-streaming room may be presented in the form of a live streamer pull-down list.

Exemplarily, as shown in FIG. 2B, when a live streamer input operation in a preset live streamer information entry box is detected, it may be determined that a live streamer recording operation for recording the live streamer information corresponding to the completed live-streaming time period is received. In this case, a live streamer pull-down list which stores at least one live streamer information associated with the target live-streaming room may be presented below the live streamer information entry box. Further, when the selection operation for the live streamer information in the live streamer pull-down list is received, the selected live streamer information is filled in the live streamer information entry box; and when a determination operation for the filled live streamer information is received, the live streamer information is presented in correspondence to the completed live-streaming time period.

It should be noted that the live streamer information may be interpreted as information related to a live streamer, including a live streamer identifier. The live streamer identifier may be a live streamer avatar, a live streamer name, etc. In addition to the live streamer identifier such as the live streamer avatar and live streamer name, gross merchandise volume (GMV) information and other live streamer information may also be presented within the completed live-streaming time period. FIG. 2B is only an example of a presenting method, and is not intended to limit the presenting content and the presenting form of the live streamer information.

The live streamer information entry box may be presented in the live-streaming information recording interface, or in the online live-streaming recording float layer. When the live streamer information entry box is presented in the online live-streaming float layer, receiving the live streamer recording operation for recording the live streamer information corresponding to the completed live-streaming time period may refer to receiving a live streamer input operation acted on the live streamer information entry box in the online live-streaming recording float layer.

It may be understood that the same completed live-streaming time period may correspond to one piece of live streamer information, or may correspond to two or more pieces of live streamer information. A piece of new live streamer information may be added by clicking on a preset control for adding the live streamer information. Optionally, the control for adding the live streamer information is set in the online live-streaming recording float layer. As shown in FIG. 2C, the control for adding the live streamer information may be presented in the online live-streaming recording float layer, e.g., may be set with “+add”.

It should be noted that a new live streamer may be created if no live streamer information to be added exists in the live streamer pull-down list. Exemplarily, the live streamer pull-down list may include an option of creating a new live streamer. As shown in FIG. 2D, a triggering operation for the option of creating the new live streamer may be received to create the live streamer information to be added.

Optionally, the method for presenting the live-streaming information in this embodiment of the present disclosure may further include: receiving a live streamer creating operation inputted based on the live-streaming information recording interface, and presenting a live streamer information entry interface; and receiving live streamer information entered based on the live streamer information entry interface and a target live-streaming room identifier associated with the entered live streamer information to associate the entered live streamer information to a live-streaming room corresponding to the target live-streaming room identifier.

The live streamer information entry interface may be interpreted as an interactive interface that supports users to create new live streamer information and establish an association between the new live streamer information and the target live-streaming room identifier. The live streamer information may include name information and avatar information of live streamers.

Optionally, receiving the live streamer information entered based on the live streamer information entry interface and the target live-streaming room identifier associated with the entered live streamer information may refer to receiving a live streamer name entered in a live streamer name entry area presented on the live streamer information entry interface; receiving a live streamer avatar entered in a live streamer image entry area presented on the live streamer information entry interface; and receiving the target live-streaming room identifier associated with the live streamer information and entered in a live-streaming room identifier entry area presented on the live streamer information entry interface.

The live streamer name may be entered by means of receiving name information filled in the live streamer name entry area. The live streamer avatar may be entered by means of receiving avatar information uploaded in a live streamer avatar entry area.

Considering that a live-streaming room identifier under the same target provider is often known information, the target live-streaming room identifier may be entered by means of presenting an account selection pull-down list and selecting from the account selection pull-down list. Optionally, receiving the target live-streaming room identifier associated with the entered live streamer information, which is entered based on the live streamer information entry interface, may refer to receiving an entry request operation acted on the live-streaming room identifier entry area on the live streamer information entry interface, presenting a live-streaming room pull-down list for storing at least one live-streaming room identifier corresponding to the object provider, receiving a live-streaming room identifier selection operation for the live-streaming room identifier in the account pull-down list, entering live-streaming room information of a live-streaming room corresponding to the selected live-streaming room identifier into the live-streaming room identification entry area as the target live-streaming room identifier associated with the entered live streamer information, and then associating the entered live streamer information to the live-streaming room corresponding to the target live-streaming room identifier.

As shown in FIG. 2D, when the live streamer creating operation inputted based on the live-streaming information recording interface is received, a window may be popped up to present the live streamer information entry interface, wherein the live streamer information entry interface may present an area for inputting a name and an avatar of a live streamer to be created, and an account (represented as an associated account in FIG. 2D) of an associated live-streaming room. As shown in a left window in FIG. 2E, the associated account may be inputted by means of presenting at least one live-streaming room identifier to be selected in the form of a live-streaming room pull-down list when an account input operation for the associated account is received. Further, when a live-streaming room identifier selection operation for the live-streaming room identifier is received, as shown in a right window in FIG. 2E, the live-streaming room information corresponding to the selected live-streaming room identifier is entered into the live-streaming identifier entry area, i.e., an input box corresponding to the associated account. Exemplarily, if all the required information has been filled in the event of receiving an information determination instruction, the entered live streamer information is associated with the live-streaming room information. The mandatory information on the live streamer information entry interface may be marked, for example, marked with “*”.

Of course, the target live-streaming room identifier may also be entered by means of receiving live-streaming account information filled in the live-streaming room identifier entry area.

Optionally, receiving the live streamer creating operation inputted based on the live-streaming information recording interface may refer to receiving a live streamer creating operation inputted in a blank displaying area on the live-streaming information recording interface in a preset triggering mode through a right mouse key or a touch object, for example, receiving a right key triggering operation of clicking the right mouse key in the blank displaying area on the live-streaming information recording interface, and presenting a right key function option corresponding to the right key triggering operation, wherein the right key function option includes a live streamer creating option; and further, receiving an option clicking operation for clicking the live streamer creating option, and taking the option clicking operation as the live streamer creating operation inputted based on the live-streaming information recording interface.

Optionally, receiving the live streamer creating operation inputted based on the live-streaming information recording interface may refer to taking the live-streaming room corresponding to the live-streaming room identifier in a selected state as a live-streaming room to be associated when the live-streaming room identifier in the selected state exists in the live-streaming information recording interface, and receiving the live streamer creating operation acted on the live-streaming room to be associated or a completed live-streaming time period corresponding to the live-streaming room to be associated.

Receiving the live streamer creating operation acted on the live-streaming room to be associated may refer to receiving a live streamer creating operation for a displaying area of the live-streaming room to be associated, wherein the live streamer creating operation may also be inputted by means of clicking a right mouse key, touching or the like. The triggering method for the live streamer creating operation is not limited herein.

Receiving the live streamer creating operation acted on the live-streaming room to be associated or the completed live-streaming time period corresponding to the live-streaming room to be associated, may, for example, refer to receiving an associated live streamer creating operation acted on the completed live-streaming time period corresponding to the live-streaming room to be associated, and presenting a live streamer pull-down list for storing an associated live streamer of the live-streaming room to be associated, wherein the live streamer pull-down list includes a live streamer creating option; and further, receiving an option clicking operation for clicking the live streamer creating option, and taking the option clicking operation as the live streamer creating operation inputted based on the live-streaming information recording interface.

As an optional implementation of this embodiment of the present disclosure, when a live streamer recording operation for recording the live streamer information corresponding to the completed live-streaming time period is received, the live streamer pull-down list for storing the associated live streamer of the associated live-streaming room is presented. As shown in FIG. 2B, the live streamer pull-down list includes a live streamer creating option and information of at least one live streamer associated with the associated live-streaming room. When the option clicking operation for clicking the live streamer creating option is received, the option clicking operation is taken as the live streamer creating operation inputted based on the live-streaming information recording interface.

Optionally, when the live streamer creating operation acted on the live-streaming room to be associated or the completed live-streaming time period corresponding to the live-streaming room to be associated is received, the target live-streaming room identifier may be displayed by default in the live-streaming room identifier entry area on the live streamer information entry interface. It should be noted that the target live-streaming room identifier which is displayed by default is supported to be altered.

The above technical solution has the advantage that the target live-streaming room identifier may be associated with a commonly used live streamer, which is convenient for one-key recording by means of a selection mode in next recording, thereby reducing the repeated entry of live streamer information, and saving time and effort. In addition, the live streamer information associated with this live-streaming room can also be intuitively viewed.

In S240, a time recording operation for recording an online live-streaming time period corresponding to the live streamer information is received, and the online live-streaming time period corresponding to the live streamer information is presented, wherein a duration of the online live-streaming time period is less than or equal to the completed live-streaming time period.

In this embodiment of the present disclosure, after the live streamer information corresponding to the completed live-streaming time period is recorded, the online live-streaming time period corresponding to the live streamer information may also be recorded. The online live-streaming time period may include a live-streaming start time and a live-streaming end time corresponding to the live streamer information.

Optionally, receiving the time recording operation for recording the online live-streaming time period corresponding to the live streamer information includes: receiving a time addition request acted on the live streamer information, presenting the online live-streaming recording float layer corresponding to the time addition request, and receiving a time addition operation for adding the online live-streaming time period corresponding to the live streamer information in the online live-streaming recording float layer.

Receiving the time addition request acted on the live streamer information may refer to receiving a live streamer clicking operation for a displaying area of the live streamer information and generating the time addition request based on the online live-streaming clicking operation; or receiving an area selection operation for the displaying area of the live streamer information, receiving a time triggering operation acted on a preset time addition control, and generating the time addition request based on the time triggering operation.

A time information entry box may be set in the online live-streaming recording float layer. Receiving the time addition operation for adding the online live-streaming time period corresponding to the live streamer information in the online live-streaming recording float layer may include: when a time input operation in the time information entry box is detected, it may be determined that a time recording operation for recording the live streamer information corresponding to the completed live-streaming time period is received. Optionally, presenting the added online live-streaming time period may include: filling the online live-streaming time period corresponding to the time input operation into the time information entry box; and presenting the added online live-streaming time period in correspondence to the live streamer information when a determination operation for the filled online live-streaming time period is received.

Optionally, the time information entry box may include a live-streaming start time entry box and a live-streaming end time entry box, which are convenient for respective recording of a live-streaming start time and a live-streaming end time.

The time input operation may be a time selection operation, that is, the live-streaming start time and the live-streaming end time which correspond to the online live-streaming time period may be selected by means of a provided time selection calendar.

Similarly, the time information entry box may be displayed in the live-streaming information recording interface, or may also be presented in the online live-streaming recording float layer. When the time information entry box is displayed in the online live-streaming recording float layer, it may be presented in correspondence to the live streamer information, e.g., presented by arrangement in the same line.

Optionally, when a first piece of live streamer information is recorded in the completed live-streaming time period, the live-streaming start time and the live-streaming end time in this live-streaming information may be defaulted to a start time and an end time of the completed live-streaming time period, respectively. It should be noted that the online live-streaming time period corresponding to this live streamer information is supported to be modified. For example, the live-streaming start time and the live-streaming end time corresponding to this live streamer information may be set by clicking this live streamer information.

It may be understood that there may be a variety of ways to present the completed live-streaming time period corresponding to the target live-streaming room. Similarly, presenting the online live-streaming time period corresponding to the live streamer information includes: presenting the online live-streaming time period corresponding to the live streamer information in the form of a Gantt chart, and/or presenting the online live-streaming time period corresponding to the live streamer information in the form of a text record. Such setting has the advantage that the online live-streaming time period of the live streamer can be clearly recorded, which is conducive to the user's intuitive perception of an online live-streaming duration of the live streamer. Meanwhile, due to the intuitiveness of the Gantt chart, it avoids an error caused by the fact that the live-streaming start time and the live-streaming end time of the live streamer recorded by the user is not in the completed live-streaming time period.

When the online live-streaming time period corresponding to the live streamer information is presented in the form of a Gantt chart, the length of the Gantt chart may represent the length of the online live-streaming time period, a start position of the Gantt chart indicates a live-streaming start time of a live streamer, and an end position of the Gantt chart indicates a live-streaming end time of this live streamer. An avatar and a name of the live streamer may be displayed in the Gantt chart.

Exemplarily, the completed live-streaming time period and the online live-streaming time period may both be presented in a Gantt chart. Exemplarily, the online live-streaming time period may also be presented in the completed live-streaming time period. In order to facilitate distinguishing, the online live-streaming time period and the completed live-streaming time period may be presented in different colors. Continuing to referring to FIGS. 1B-1D, if there are overlapped live-streaming start times in the online live-streaming time periods of different live streamers within the same completed live-streaming time period, the live-streaming start times in the online live-streaming time periods of the live streamers which may overlap may be displayed in separate lines. For example, the online live-streaming time period with a later live-streaming start time is presented in the next line of the online live-streaming time period with an earlier live-streaming start time. If there is no overlap in the live-streaming start times for the respective live streamers, the online live-streaming time periods corresponding to respective live streamers may be displayed in the same line.

In the technical solution of this embodiment, the live streamer information corresponding to the completed live-streaming time period is presented by receiving an addition operation for adding the live streamer information corresponding to the completed live-streaming time period, which is especially suitable for a case that a plurality of live streamers carries out live-streaming in the same completed live-streaming time period. In addition, the online live-streaming time periods of the live streamers may also be recorded, thereby achieving the technical effect of elaborate recording of the live-streaming information, meeting the user's personalized interaction needs, and improving the user experience.

With a live-streaming sales scenario as an example, if the object provider is a merchant account, a plurality of live-streaming rooms (also known as expert accounts) is set under this merchant account, and there may be a plurality of live streamers who takes turns or cooperates with each other to perform live-streaming under each expert account. For example, an expert account has a live-streaming session on a certain day and continues this session for 9 h, where live streamer 1 is responsible for the first 3 hours, live streamer 2 for the middle 3 hours, and live streamer 3 for the last 3 hours. The related technical solutions often only focus on data presentations of the entire live-streaming session, such as a transaction amount and an increase in number of fans. However, it is not possible to distinguish the data of the three live streamers.

In the technical solution of this embodiment, through the distribution of the online live-streaming times of the respective live streamers in the live-streaming sessions that have been carried out by all expert accounts under the merchant account, merchants can manage online live-streaming records more easily and accurately, and also know which live streamer is on line in each time period within the completed live-streaming time period. Thus, it is convenient to match the data presentation of each completed live-streaming time period with the live streamer, and the live-streaming information can be recorded more accurately and completely, thereby facilitating subsequent data analysis for each live streamer.

### Embodiment 3

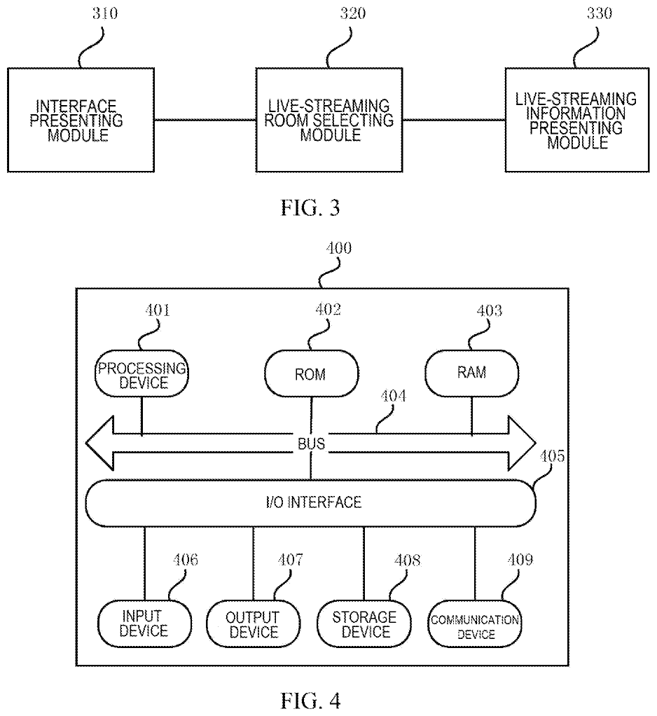

FIG. 3 is a schematic structural diagram of an apparatus for presenting live-streaming information provided by Embodiment 3 of the present disclosure. This apparatus for presenting the live-streaming information provided by this embodiment may be implemented through software and/or hardware, and may be disposed in a terminal and/or server to implement the method for presenting live-streaming information according to the embodiments of the present disclosure.

As shown in FIG. 3, this apparatus includes an interface presenting module 310, a live-streaming room selecting module 320 and a live-streaming information presenting module 330.

The interface presenting module 310 is configured to receive a live-streaming information recording request for an object provider, and present a live-streaming information recording interface, wherein the live-streaming information recording interface presents at least one live-streaming room identifier corresponding to the object provider. The live-streaming room selecting module 320 is configured to receive a live-streaming room identifier selection operation inputted for the at least one live-streaming room identifier, take a live-streaming room corresponding to the selected live-streaming room identifier as a target live-streaming room, and present a completed live-streaming time period corresponding to the target live-streaming room. The live-streaming information presenting module 330 is configured to receive an information input operation for the completed live-streaming time period, and present live-streaming information corresponding to the information input operation.

In the technical solution of this embodiment of the present disclosure, by receiving the live-streaming information recording request for the object provider, the live-streaming information recording interface is presented. Thus, in respond to the live-streaming information recording request, the live-streaming information recording interface can be presented to provide a way to interact with users. Then, the live-streaming room identifier selection operation inputted based on the at least one live-streaming room identifier is received to accurately capture a user's viewing intent for the live-streaming room. Further, the completed live-streaming time period corresponding to the selected live-streaming room is presented, and live-streaming time periods of respective live-streaming sessions that have been carried out in the target live-streaming room can be recorded and presented automatically for users to view, thereby saving time resources and human resources for recording by the users themselves. In addition, the information input operation based on the completed live-streaming time period can further be received, the live-streaming information corresponding to the information input operation is presented, and the user's personalized recording needs are further supported based on automatic recording of the completed live-streaming time period, so that the user is supported to record the live-streaming information independently. The above-mentioned technical solution solves the problems of imperfect system interactivity, insufficient systematization, large time consumption, error proneness and high possibility of data resource waste caused by manual recording of the live-streaming data, and can realize the systematic recording of the live-streaming information, which is convenient for the subsequent management, viewing and application of the live-streaming information, thereby improving the user experience.

Based on the above technical solutions, the live-streaming information presenting module may include:
a live streamer live-streaming information presenting module, configured to receive a live streamer information addition operation for adding live streamer information corresponding to the completed live-streaming time period, and present the live streamer information corresponding to the completed live-streaming time period.

Based on the above technical solutions, the live streamer live-streaming information presenting module may be configured to:
receive a live streamer recording operation for recording the live streamer information corresponding to the completed live-streaming time period, and present at least one live streamer identifier associated with the target live-streaming room; and
receive a live streamer identifier selection operation for at least one live streamer identifier associated with the target live-streaming room, and present the live streamer information corresponding to the completed live-streaming time period.

Based on the above technical solutions, the apparatus for presenting the live-streaming information may further include:
a live streamer creating interface presenting module, configured to receive a live streamer creating operation inputted based on the live-streaming information recording interface, and present a live-streaming information entry interface;
a creation information associating module, configured to receive live streamer information entered based on the live streamer information entry interface and a target live-streaming room identifier associated with the entered live streamer information to associate the entered live streamer information to a live-streaming room corresponding to the target live-streaming room identifier.

Based on the above technical solutions, the apparatus for presenting the live-streaming information may further include:
a time live-streaming information presenting module, configured to receive a time recording operation for recording an online live-streaming time period corresponding to the live streamer information, and present the online live-streaming time period corresponding to the live streamer information, wherein a duration of the online live-streaming time period is less than or equal to the completed live-streaming time period.

Based on the above technical solutions, the time live-streaming information presenting module may be configured to:
present the completed live-streaming time period corresponding to the live streamer information in the form of a Gantt chart.

Based on the above technical solutions, the apparatus for presenting the live-streaming information may further include:
an activating module, configured to receive a recording activating operation acted on the completed live-streaming time period prior to receiving the information input operation inputted based on the completed live-streaming time period, and switch the completed live-streaming time period to an activated state.

Based on the above technical solutions, the apparatus for presenting the live-streaming information may further include:
a live-streaming room identifier switching module, configured to receive a live-streaming room identifier switching operation inputted based on the live-streaming information recording interface, and switch at least one live-streaming room identifier currently presented in the live-streaming information recording interface.

Based on the above technical solutions, the live-streaming information presenting module may be configured to:
present the completed live-streaming time period in a first presenting state if no live-streaming information is recorded within the completed live-streaming time period corresponding to the target live-streaming room; and
present the completed live-streaming time period and recorded live-streaming information in a second presenting state if the live-streaming information has been recorded within the completed live-streaming time period corresponding to the target live-streaming room.

Based on the above technical solutions, the apparatus for presenting the live-streaming information may further include:
a presentation time selecting module, configured to receive a time selection operation inputted based on the live-streaming information recording interface, and present the completed live-streaming time period which corresponds to the target live-streaming room and is within a target time period corresponding to the time selection operation.

The apparatus for presenting the live-streaming information provided by this embodiment of the present disclosure may execute the method for presenting the live-streaming information provided by any embodiment of the present disclosure, and has corresponding functional modules for implementing the method for presenting the live-streaming information.

It is worth noting that, each unit and module included in the apparatus for presenting the live-streaming information are only divided according to functional logic, but not limited to the above division, as long as the corresponding functions can be achieved. In addition, the specific name of each functional unit is only for the convenience of distinguishing each other, and is not used to limit the protection scope of the present disclosure.

### Embodiment 4

Referring to FIG. 4 below, FIG. 4 is a schematic structural diagram of an electronic device (a terminal device or a server) 400 according to an embodiment of the present disclosure. The terminal device in this embodiment of the present disclosure includes, but is not limited to, a mobile phone, a notebook computer, a digital broadcast receiver, a personal digital assistant (PDA), a portable Android device (PAD), a portable media player (PMP), a vehicle-mounted terminal (e.g., a vehicle-mounted navigation terminal) or other mobile terminal, and a digital television (TV), a desktop computer or other fixed terminal. The electronic device shown in FIG. 7 is only an example and should not impose any limitation on the functionality and scope of use in the embodiments of the present disclosure.

As shown in FIG. 4, the electronic device 400 may include a processing device (e.g., a central processing unit, a graphics processing unit and the like) 401, which may perform various appropriate actions and processing according to a program stored in a read-only memory (ROM) 402 or a program that is loaded into a random access memory (RAM) from a storage device 406. The RAM 403 further stores various programs and data required for the operations of the electronic device 400. The processing device 401, the ROM 402 and the RAM 403 are connected to each other via a bus 404. An input/output (I/O) interface 405 is also connected to the bus 404.

Typically, the following devices may be connected to the I/O interface 405: an input device 406 including a touch screen, a touchpad, a keyboard, a mouse, a camera, a microphone, an accelerometer, a gyroscope, etc.; an output device 407 including a liquid crystal display (LCD), a speaker, a vibrator, etc.; a storage device 406 including a magnetic tape, a hard disk, etc.; and a communication device 409. The communication device 409 may allow the electronic device 400 and other devices to communicate in a wireless or wired manner to exchange data. Although FIG. 4 shows the electronic device 400 equipped with various devices, it should be understood that not all the apparatuses shown need to be implemented or equipped. More or fewer devices may be implemented or equipped alternatively.

In particular, according to the embodiments of the present disclosure, the process described above with reference to the flowchart may be implemented as a computer software program. For example, an embodiment of the present disclosure includes a computer program product. The computer program product includes a computer program loaded on a non-transient computer-readable medium, and the computer program includes a program code configured to perform the method shown in the flowchart. In such an embodiment, the computer program may be downloaded and installed from the network via the communication device 409, or installed from the storage device 406, or installed from the ROM 402. When this computer program is executed by the processing device 401, the above functions as defined in the method of the embodiments of the present disclosure are performed.

The electronic device provided in this embodiment and the method for presenting the live-streaming information provided in the above embodiment belong to the same disclosure concept, and the technical details that are not described in detail in this embodiment can be found in the above embodiments.

### Embodiment 5

A computer storage medium is provided according to an embodiment of the present disclosure. The computer storage medium stores a computer program therein, wherein the program, when being executed by a processor, implements the method for presenting the live-streaming information provided by any of the above embodiments.

It should be noted that the computer-readable medium described in the present disclosure may be a computer-readable signal medium or a computer-readable storage medium, or any combination of the two. The computer-readable storage medium may be, for example, but is not limited to electrical, magnetic, optical, electromagnetic, infrared, or semiconductor systems, apparatuses or devices, or any combination thereof. More specific examples of the computer-readable storage medium include, but are not limited to: an electric connector having one or more leads, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof. In the present disclosure, the computer-readable storage medium may be any tangible medium including or storing a program, which may be used by an instruction execution system, apparatus or device or used in combination therewith. In the present disclosure, the computer-readable signal medium may include a data signal included in a baseband or propagated as part of a carrier which carries computer-readable program codes. This propagated data signal may take many forms, including but not limited to, an electromagnetic signal, an optical signal, or any suitable combination of the foregoing. The computer-readable signal medium may also be any computer-readable medium other than the computer-readable storage medium. The computer-readable signal medium may send, propagate, or transmit programs used by or used in combination with the instruction execution system, apparatus or device. The program codes contained in the computer-readable medium may be transmitted using any appropriate medium, including but not limited to: a wire, an optical cable, an RF (radio frequency), etc., or any suitable combination thereof.

In some embodiments, a client and a server may communicate using any currently known or future-developed network protocol such as HTTP (HyperText Transfer Protocol), and can be interconnected with digital data communication in any form or medium (e.g., communication network). Examples of communication networks include a local area network (LAN), a wide area network (WAN), an internet network (e.g., the Internet), and an end-to-end network (e.g., ad hoc end-to-end network), as well as any networks that are known currently or developed in the future.

The computer-readable medium may be contained in the electronic device, or may also exist alone while not be assembled into the electronic device.

The computer-readable medium carries at least one program, and the program, when being executed by this electronic device, enables this electronic device to:
receive a live-streaming information recording request for an object provider, and present a live-streaming information recording interface, wherein the live-streaming information recording interface presents at least one live-streaming room identifier corresponding to the object provider;
receive a live-streaming room identifier selection operation for the at least one live-streaming room identifier, take a live-streaming room corresponding to the selected live-streaming room identifier as a target live-streaming room, and present a completed live-streaming time period corresponding to the target live-streaming room; and
receive an information input operation for the completed live-streaming time period, and present live-streaming information corresponding to the information input operation.

Computer program codes for performing the operations of the present disclosure may be written in one or more programming languages or a combination thereof, wherein the programming languages include, but are not limited to, object-oriented programming languages, such as Java, Smalltalk and C++, as well as conventional procedural programming languages, such as “C” language or similar programming languages. The program codes may be executed entirely on a user computer, partly on a user computer, as a stand-alone software package, partly on the user computer and partly on a remote computer, or completely on a remote computer or a server. In a case of the remote computer, the remote computer may be connected to the user computer through any type of network (including a local area network (LAN) or wide area network (WAN)), or may be connected to an external computer (e.g., through the Internet by using an Internet service provider).

The flowcharts and block diagrams in the accompanying drawings illustrate the system architecture, functions and operations of the system, method and computer program product that may be implemented in accordance with various embodiments of the present disclosure. At this point, each block in the flowchart or block diagram may represent a module, a program segment, or part of code that contains at least one executable instruction for implementing a specified logical function. It should also be noted that in some alternative implementations, the functions marked in the block may also occur in a different order than those marked in the accompanying drawings. For example, two blocks represented consecutively may actually be performed in substantially parallel, and they may sometimes be performed in a reverse order, depending on the functions involved. It should also be noted that each block in the block diagram and/or flowchart, and the combination of blocks in the block diagram and/or flowchart may be implemented by using a dedicated hardware-based system that performs a specified function or operation, or may be implemented by using a combination of dedicated hardware and computer instructions.

The units involved in the embodiments of the present disclosure may be implemented by means of software, or by means of hardware. Here, the names of the units and modules do not limit the units and modules themselves under certain circumstances. For example, the live-streaming information presenting module may also be described as an “information recording module”.

The functions described herein above can be implemented by at least in part by at least one hardware logical components. For example, non-limitatively, the hardware logic components that can be used in the following types include: a field programmable gate array (FPGA), an application specific integrated circuit (ASIC), an application specific standard parts (ASSP), a system on chip (SOC), a complex programmable logic device (CPLD), and the like.

In the context of the present disclosure, a machine-readable medium may be a tangible medium which may include or store a program for use by or in combination with an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses or devices, or any combination thereof. More specific examples of the machine-readable storage medium may include: an electric connector having at least one lead, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

In particular, according to the embodiments of the present disclosure, the process described above with reference to the flowchart may be implemented as a computer program product. For example, an embodiment of the present disclosure includes a computer program product. The computer program product includes a computer program loaded on a computer-readable medium, and the computer program product includes a program code configured to perform the method shown in the flowchart. In such an embodiment, the computer program may be downloaded and installed from a network via a communication apparatus, or installed from a storage apparatus, or installed from the ROM. When the computer program is executed by the processor, the above functions defined in the method of the embodiments of the present disclosure are performed.

According to at least one embodiment of the present disclosure, Example 1 provides a method for presenting live-streaming information. The method includes:
receiving a live-streaming information recording request for an object provider, and presenting a live-streaming information recording interface, wherein the live-streaming information recording interface presents at least one live-streaming room identifier corresponding to the object provider;
receiving a live-streaming room identifier selection operation for the at least one live-streaming room identifier, taking a live-streaming room corresponding to the selected live-streaming room identifier as a target live-streaming room, and presenting a completed live-streaming time period corresponding to the target live-streaming room; and
receiving an information input operation for the completed live-streaming time period, and presenting live-streaming information corresponding to the information input operation.

According to at least one embodiment of the present disclosure, Example 2 provides a method for presenting live-streaming information. The method further includes the following step.

Optionally, receiving the information input operation for the completed live-streaming time period, and presenting the live-streaming information corresponding to the information input operation include:
receiving a live streamer information addition operation for adding live streamer information corresponding to the completed live-streaming time period, and presenting the live streamer information corresponding to the completed live-streaming time period.

According to at least one embodiment of the present disclosure, Example 3 provides a method for presenting live-streaming information. The method further includes the following step.

Optionally, receiving the live streamer information addition operation for adding the live streamer information corresponding to the completed live-streaming time period, and presenting the live streamer information corresponding to the completed live-streaming time period include:
receiving a live streamer recording operation for recording the live streamer information corresponding to the completed live-streaming time period, and presenting at least one live streamer identifier associated with the target live-streaming room; and
receiving a live streamer identifier selection operation for at least one live streamer identifier associated with the target live-streaming room, and presenting the live streamer information corresponding to the completed live-streaming time period.

According to at least one embodiment of the present disclosure, Example 4 provides a method for presenting live-streaming information. The method further includes the following steps.

Optionally, receiving a live streamer creating operation inputted based on the live-streaming information recording interface, and presenting a live-streaming information entry interface; and
receiving live streamer information entered based on the live streamer information entry interface and a target live-streaming room identifier associated with the entered live streamer information to associate the entered live streamer information to a live-streaming room corresponding to the target live-streaming room identifier.

According to at least one embodiment of the present disclosure, Example 5 provides a method for presenting live-streaming information. The method further includes:
receiving a time recording operation for recording an online live-streaming time period corresponding to the live streamer information, and presenting the online live-streaming time period corresponding to the live streamer information, wherein a duration of the online live-streaming time period is less than or equal to the completed live-streaming time period.

According to at least one embodiment of the present disclosure, Example 6 provides a method for presenting live-streaming information. The method further includes the following step.

Optionally, presenting the completed live-streaming time period corresponding to the live streamer information includes:
presenting the completed live-streaming time period corresponding to the live streamer information in the form of a Gantt chart.

According to at least one embodiment of the present disclosure, Example 7 provides a method for presenting live-streaming information. The method further includes the following step:
optionally, prior to receiving the information input operation for the completed live-streaming time period, receiving a recording activation operation acted on the completed live-streaming time period, and switching the completed live-streaming time period to an activated state.

According to at least one embodiment of the present disclosure, Example 8 provides a method for presenting live-streaming information. The method further includes:
receiving a live-streaming room identifier switching operation inputted based on the live-streaming information recording interface, and switching at least one live-streaming room identifier currently presented in the live-streaming information recording interface.

According to at least one embodiment of the present disclosure, Example 9 provides a method for presenting live-streaming information. The method further includes the following step.

Optionally, presenting the completed live-streaming time period corresponding to the target live-streaming room includes:
presenting the completed live-streaming time period in a first presenting state if no live-streaming information is recorded within the completed live-streaming time period corresponding to the target live-streaming room; and
presenting the completed live-streaming time period and recorded live-streaming information in a second presenting state if the live-streaming information has been recorded within the completed live-streaming time period corresponding to the target live-streaming room.

According to at least one embodiment of the present disclosure, Example 10 provides a method for presenting live-streaming information. The method further includes:
receiving a time selection operation inputted based on the live-streaming information recording interface, and presenting a completed live-streaming time period which corresponds to the target live-streaming room and is within the target time period corresponding to the time selection operation.

According to at least one embodiment of the present disclosure, Example 11 provides an apparatus for presenting live-streaming information. The apparatus includes:
an interface presenting module, configured to receive a live-streaming information recording request for an object provider, and present a live-streaming information recording interface, wherein the live-streaming information recording interface presents at least one live-streaming room identifier corresponding to the object provider;
a live-streaming room selecting module, configured to receive a live-streaming room identifier selection operation inputted for the at least one live-streaming room identifier, take a live-streaming room corresponding to the selected live-streaming room identifier as a target live-streaming room, and present a completed live-streaming time period corresponding to the target live-streaming room; and
a live-streaming information presenting module, configured to receive an information input operation for the completed live-streaming time period, and present live-streaming information corresponding to the information input operation.

In addition, although various operations are depicted in a specific order, this should not be understood as requiring these operations to be performed in the shown specific order or performed in a sequential order. In certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

1. A method for presenting information, comprising:
in response to receiving a live-streaming information recording request, presenting a recording interface, the recording interface presenting a plurality of identifiers indicating a plurality of associated live-streaming accounts; and
in response to receiving a selection of a target identifier of the plurality of identifiers, presenting time information corresponding to a target live-streaming account, the time information indicating a target time period live-streamed by a target live-streaming account corresponding to the selected target identifier.

2.-6. (canceled)

7. The method of claim 1, further comprising:
receiving a recording activation operation for the target time period; and
switching the target time period to an activated state.

8.-9. (canceled)

10. The method of claim 1, further comprising:
receiving a switching operation on the recording interface; and
switching at least one live-streaming room account currently presented in the recording interface.

11. (canceled)

12. An electronic device, comprising:
at least one processor; and
a storage apparatus configured to store at least one program, wherein
the at least one program, when executed by the at least one processor, enables the at least one processor to implement operations comprising:
in response to receiving a live-streaming information recording request, presenting a recording interface, the recording interface presenting a plurality of identifiers indicating a plurality of associated live-streaming accounts; and
in response to receiving a selection of a target identifier of the plurality of identifiers, presenting time information corresponding to a target live-streaming account, the time information indicating a target time period live-streamed by a target live-streaming account corresponding to the selected target identifier.

13. A non-transitory computer-readable storage medium, configured to store a computer program therein, wherein the computer program, when executed by a processor, implements operations comprising:
in response to receiving a live-streaming information recording request, presenting a recording interface, the recording interface presenting a plurality of identifiers indicating a plurality of associated live-streaming accounts; and
in response to receiving a selection of a target identifier of the plurality of identifiers, presenting time information corresponding to a target live-streaming account, the time information indicating a target time period live-streamed by a target live-streaming account corresponding to the selected target identifier.

14. (canceled)

15. The method of claim 1, wherein the plurality of associated live-streaming accounts are corresponding to an object provider.

16. The method of claim 1, further comprising:
receiving an information input operation for the target time period, and
presenting live-streaming information corresponding to the information input operation.

17. The method of claim 16, wherein presenting live-streaming information corresponding to the information input operation comprises:
in response to receiving an addition operation for adding live streamer information corresponding to the target time period, presenting the live streamer information corresponding to the target time period.

18. The method of claim 17, wherein in response to receiving an addition operation for adding live streamer information corresponding to the target time period presenting the live streamer information corresponding to the target time period comprises:
receiving a recording operation for recording the live streamer information corresponding to the target time period;
presenting at least one live streamer identifier associated with the target live-streaming account;
receiving a selection of a target live streamer identifier of the at least one live streamer; and
presenting the live streamer information corresponding to the target live streamer.

19. The method of claim 18, further comprising:
in response to receiving a creating operation on the recording interface, presenting a live-streaming information inputting interface;
receiving live streamer information input through the live streamer information inputting interface and a specified target live-streaming account; and
associating the input live streamer information with the specified live-streaming account.

20. The method of claim 17, further comprising:
receiving a time recording operation for recording an online live-streaming time period corresponding to the live streamer information; and
presenting the online live-streaming time period corresponding to the live streamer information, wherein a duration of the online live-streaming time period is shorter than or equal to the target time period.

21. The method of claim 20, wherein presenting the online live-streaming time period corresponding to the live streamer information comprises:
presenting the online live-streaming time period corresponding to the live streamer information in a form of a Gantt chart.

22. The method of claim 1, wherein presenting time information corresponding to a target live-streaming account comprises:
in response to no live-streaming information having been recorded within the target time period corresponding to the target live-streaming account, presenting the target time period in a first presenting state; and
in response to the
live-streaming information having been recorded within the target time period corresponding to the target live-streaming account, presenting the target time period and the recorded live-streaming information in a second presenting state.

23. The method of claim 1, further comprising:
receiving a time selection operation indicating a first time period on the recording interface; and
presenting a second time period live-streamed by the target live-streaming account, the second time period being within the first time period indicated by the time selection operation.

24. The electronic device of claim 12, wherein the plurality of associated live-streaming accounts are corresponding to an object provider.

25. The electronic device of claim 12, the operations further comprising:
receiving an information input operation for the target time period, and
presenting live-streaming information corresponding to the information input operation.

26. The electronic device of claim 25, wherein presenting live-streaming information corresponding to the information input operation comprises:
in response to receiving an addition operation for adding live streamer information corresponding to the target time period, presenting the live streamer information corresponding to the target time period.

27. The electronic device of claim 26, wherein in response to receiving an addition operation for adding live streamer information corresponding to the target time period presenting the live streamer information corresponding to the target time period comprises:
receiving a recording operation for recording the live streamer information corresponding to the target time period;
presenting at least one live streamer identifier associated with the target live-streaming account;
receiving a selection of a target live streamer identifier of the at least one live streamer; and
presenting the live streamer information corresponding to the target live streamer.

28. The electronic device of claim 27, wherein the operations further comprise:
in response to receiving a creating operation on the recording interface, presenting a live-streaming information inputting interface;
receiving live streamer information input through the live streamer information inputting interface and a specified target live-streaming account; and
associating the input live streamer information with the specified live-streaming account.

29. The electronic device of claim 27, wherein the operations further comprise:
receiving a time recording operation for recording an online live-streaming time period corresponding to the live streamer information; and
presenting the online live-streaming time period corresponding to the live streamer information, wherein a duration of the online live-streaming time period is shorter than or equal to the target time period.
